(19) United States
(12) Patent Application Publication
(10) Pub. No.: US 2008/0198306 A1
(43) Pub. Date: Aug. 21, 2008

(54) Transflective Liquid Crystal Display Device

(75) Inventor: Minoru Shibazaki, Tokyo (JP)

Correspondence Address: LIU & LIU, 444 S. FLOWER STREET, SUITE 1750, LOS ANGELES, CA, 90071, US

(73) Assignee: KONINKLIJKE PHILIPS ELECTRONICS N.V., Eindhoven (NL)

(21) Appl. No.: 10/566,071

(22) PCT Filed: Jul. 27, 2004
(86) PCT No.: PCT/IB2004/051295

§ 371 Date: Jan. 2, 2008

(30) Foreign Application Priority Data
Jul. 28, 2003 (IB) PCT/IB03/03355

(51) Int. Cl. G02F 1/1335

(52) U.S. Cl. 349/98

(57) ABSTRACT

In a transmissive mode, the light emitted from a backlight (11) in reflective region B passes through a circularly polarized light plate (13). The light passed through the circularly polarized light plate (13) becomes the right circularly polarized light by the absorption of a part of the left circularly polarized light by the absorption of a part of the left circularly polarized light, If the right circularly polarized light launches into a retardation film (12e) of a liquid crystal panel (12), a phase of the light delays with λ/4. The light delayed with λ/4 becomes the linearly polarized light and is reflected on a reflective film (12d). The light reflected on the reflective film (12d) delays its phase with λ/4 by the retardation film (12e). Therefore, the right circularly polarized light, passed through the retardation film (12e) again, returns to the right circularly polarized light. The right circularly polarized light passes through the circularly polarized light plate (13) as the right circularly polarized light plate, reflects on a reflective film (11b) of the backlight (11), and is diffused by a diffusing film (11a). The right circularly polarized light returns to the natural light as well as the light from the backlight (11) with a circularly polarized state canceled when passing through the diffusing film (11a). The light reflected on the backlight (11) adds to the light emitted directly from the backlight (11) in a transmissive region A.

### TECHNICAL FIELD

The present invention relates to a transflective liquid crystal display device, in particular to a transflective liquid crystal display device using the light from a backlight efficiently.

### BACKGROUND ART

A so-called transflective liquid crystal display device, which reflects ambient light incident from a front side, leads the reflected light to the front side and at the same time allows incident light from a backlight system on the back to pass therethrough so as to be led to the same front side, is becoming commercialized with reality. This type of liquid crystal display device displays images effectively using principally ambient light when an operating environment is bright (reflective mode) and principally spontaneous light of the backlight system (transmissive mode) when the operating environment is dark.

Prior art documents US2001/0017679 and US2002/0089623 disclose this type of liquid crystal display device.

Here, a conventional transflective liquid crystal display device will be explained using FIG. 1. FIG. 1 is a sectional view diagrammatically showing an arrangement of a conventional transflective liquid crystal display device.

The transflective liquid crystal display device in FIG. 1 is principally constructed of a backlight 1 used in a transmissive mode, a liquid crystal panel 2 arranged above this backlight 1 and a pair of circularly polarized light plates 3, 4 arranged to sandwich this liquid crystal panel 2.

The backlight 1 is constructed of a light guide plate 1c which guides light and a light source (not shown) arranged at an end of the light guide plate 1c. A diffusing film 1a which diffuses light emitted onto the liquid crystal panel 2 through the light guide plate 1c is formed on the surface of the light guide plate 1c on a side of the liquid crystal panel 2 and a reflective film 1b which reflects light from the light source is formed on the surface opposite to the surface of the light guide plate 1c on a side of the liquid crystal panel 2.

The liquid crystal panel 2 includes a pair of glass substrates 2a, 2b, a liquid crystal layer 2c sandwiched therebetween, a stepwise member 2e provided on a reflective region B on the glass substrate 2a and a reflective film 2d formed on the stepwise member 2e.

Pixels are formed on the glass substrate 2a and each pixel is provided with the reflective region B having the reflective film 2d and the transmissive region A (region without any reflective film) having an opening for allowing light from the backlight 1 to pass therethrough. In each pixel, the reflective region B is formed to surround the transmissive region A.

The liquid crystal panel 2 has electrodes, a color filter, an orientation film which controls the orientation of liquid crystal molecules, but explanations thereof will be omitted here for simplicity of explanation.

The circularly polarized light plates 3, 4 are circularly polarized light plates having polarization directions opposite to each other. Here, suppose the circularly polarized light plate 3 is a right circularly polarized light plate and the circularly polarized light plate 4 is a left circularly polarized light plate.

In the transflective liquid crystal display device in the above described structure, when the light from the backlight 1 is used as a light source in a transmissive mode, the light emitted from the backlight 1 passes through the circularly polarized light plate 3 in the reflective region B. Since the circularly polarized light plate 3 is a right circularly polarized light plate, a part of the left circularly polarized light of the light which has passed through the circularly polarized light plate 3 is absorbed and becomes the right circularly polarized light.

This right circularly polarized light is reflected on the reflective film 2d. The light reflected on the reflective film 2d is changed from the right circularly polarized light to the left circularly polarized light. When this left circularly polarized light returns to the circularly polarized light plate 3, the left circularly polarized light is absorbed by the circularly polarized light plate 3 and cannot pass through the circularly polarized light plate 3 because the circularly polarized light plate 3 is a right circularly polarized light plate.

As described above, in the transflective liquid crystal display device, each pixel has a reflective region and a transmissive region. Since the reflective region is normally wider than the transmissive region, when the light from the backlight 1 is reflected on the reflective film 2d as shown above and the light from the backlight 1 is consequentially absorbed by the circularly polarized light plate 3, a great portion of the backlight 1 is not fully used in a transmissive mode.

### DISCLOSURE

It is an object of the present invention to provide a transflective liquid crystal display device which is able to use the light from a backlight efficiently in a transmissive mode.

The transflective liquid crystal display device according to the present invention has a liquid crystal panel in which liquid crystal material is sealed between a pair of substrates faced with each other and in which pixels formed on one substrate of the pair of substrates have transmissive regions and reflective regions, comprising a pair of circularly polarized light members arranged outside the liquid crystal panel and a backlight arranged outside one circularly polarized light member of the pair of circularly polarized light members, wherein the reflective region has a reflective member for reflecting ambient light from an opposite side of backlight-arranging side in the liquid crystal panel, and the reflective region has phase difference forming means arranged on the backlight-arranging side of the reflective member.

This structure allows the phase difference forming means to reverse the polarization direction of the circularly polarized light from the backlight in the reflective region. This allows the light reflected on the reflective member to pass through the circularly polarized light member. Therefore, the light from the backlight in the reflective region which conventionally used to be wasted without being used can be used in a transmissive mode.

In the transflective liquid crystal display device according to the present invention, the phase difference forming means preferably has a function of reversing a direction of circularly polarized light by allowing circularly polarized light to pass therethrough twice.

In an embodiment of the transflective liquid crystal display device according to the present invention, the phase difference forming means is formed on the reflective regions in a main surface inside the liquid crystal panel on one substrate on the backlight-arranging side of a pair of substrates and the reflective member is formed on the phase difference forming means. In this case, the phase difference forming means is preferably a retardation film for delaying phase with λ/4. Furthermore, the phase difference forming means also serves as a stepwise member for adjusting a balance between transmittance in the transmissive region and reflectance in the reflective region.

In another embodiment of the transflective liquid crystal display device according to the present invention, the phase difference forming means is orientation-processed polymer liquid crystal layer. In this case, the polymer liquid crystal layer preferably delays phase with λ/4.

In a further embodiment of the transflective liquid crystal display device according to the present invention, the phase difference forming means is formed on the reflective regions in a main surface outside the liquid crystal panel on one substrate on the backlight-arranging side of a pair of substrates. In this case, the phase difference forming means is preferably a retardation film or a phase difference film for delaying phase with λ/4.

### DESCRIPTION OF DRAWINGS

FIG. 1 is a sectional view diagrammatically showing an arrangement of a conventional transflective liquid crystal display device;

FIG. 2 is a sectional view diagrammatically showing an arrangement of a transflective liquid crystal display device according to an Embodiment 1 of the present invention;

FIG. 3a is a sectional view showing another example of phase difference forming means in a transflective liquid crystal display device according to an Embodiment 2 of the present invention; and

FIG. 3b is a sectional view showing another example of phase difference forming means in a transflective liquid crystal display device according to an Embodiment 3 of the present invention.

### BEST MODE

With reference now to the attached drawings, embodiments of the present invention will be explained in detail below.

### Embodiment 1

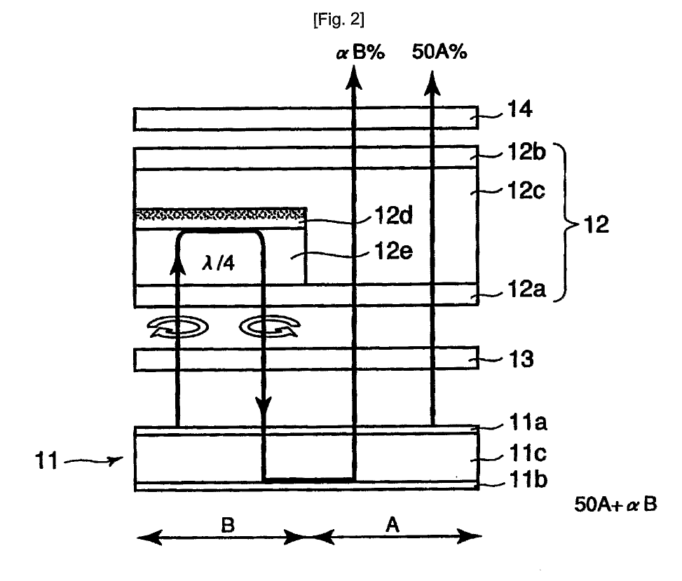

FIG. 2 is a sectional view diagrammatically showing an arrangement of a transflective liquid crystal display device according to an Embodiment 1 of the present invention. In FIG. 2, the transflective liquid crystal display device actually includes electronic devices and optical devices such as electrodes, a color filter, an orientation film, but explanations thereof will be omitted here for simplicity of explanation.

The transflective liquid crystal display device in FIG. 2 are principally constructed of a backlight 11 used in a transmissive mode, a liquid crystal panel 12 arranged above this backlight 11 and a pair of circularly polarized light plates 13, 14 arranged to sandwich this liquid crystal panel 12.

The backlight 11 is constructed of a light guide plate 11c and a light source (not shown) arranged at an end of the light guide plate 11c. A diffusing film 11a which diffuses light emitted onto the liquid crystal panel 12 through the light guide plate 11c is provided on the surface of the light guide plate 11c on a side of the liquid crystal panel 12 and a reflective film 11b which reflects light from the light source is provided on the surface opposite to the surface of the light guide plate 11c on a side of the liquid crystal panel 12.

In the backlight 11 with the above-mentioned structure, the light emitted from the light source enters the light guide plate 11c, is reflected on the reflective film 11b of the light guide plate 1c and directed toward the liquid crystal panel 12 (upward in FIG. 2). This light is diffused by the diffusing film 11a of the light guide plate 11c and used as the light of the backlight 11 in a transmissive mode.

An LED (light-emitting diode), etc., can be used as the light source. Furthermore, a metal film such as an aluminum film can be used as the reflective film 11b. Furthermore, a polycarbonate film containing diffusing grains, etc., can be used as the diffusing film 11a.

The liquid crystal panel 12 includes a pair of glass substrates 12a, 12b, a liquid crystal layer 12c sandwiched therebetween, a retardation film 12e which is phase difference forming means provided in a reflective region B on the glass substrate 12a and a reflective film 12d formed on the retardation film 12e. This retardation film 12e has a function of delaying phase with, for example, ¼ (approximately 100 to 200 nm). A resin material such as polycarbonate can be used as the material of the retardation film 12e.

Pixels are formed on the glass substrate 12a and each pixel is provided with the reflective region B having the reflective film 12d and the transmissive region A (region without any reflective film) having an opening for allowing the light from the backlight 11 to pass therethrough. In the respective pixels, the reflective region B is formed to surround the transmissive region A.

When the reflective region B and transmissive region A are formed using the retardation film 12e, the retardation film 12e is formed on the glass substrate 12a first.

For example, the retardation film 12e is formed by coating the glass substrate 12a with the resin material for the retardation film using a spin coating method, etc.

Since this retardation film 12e can also serve as the stepwise member, it is possible to simplify the manufacturing steps. The stepwise member is provided to adjust a balance between transmittance in the transmissive mode and reflectance in the reflective mode and it is preferable to set the ratio of the cell gap in the reflective region B to the cell gap in the transmissive region A to approximately 1:2. To realize this ratio, the thickness of the stepwise member is normally controlled.

Then, the reflective film 12d is formed on the retardation film 12e. For example, the reflective film 12d is formed by coating the retardation film 12e with the material for the reflective film such as aluminum using a sputtering method, etc. Then, the reflective film 12d and retardation film 12e are patterned and an opening corresponding to the transmissive region A is formed. Therefore, the reflective film 12d is provided on the reflective region B of the glass substrate 12a through the retardation film 12e.

This results in a structure with the retardation film 12e which is phase difference forming means arranged on the backlight side of the reflective film 12d which is the reflective member in the reflective region B.

The circularly polarized light plates 13, 14 are circularly polarized light plates having polarization directions opposite to each other. Here, suppose the circularly polarized light plate 13 is a right circularly polarized light plate and the circularly polarized light plate 14 is a left circularly polarized light plate. The circularly polarized light plates 13, 14 can be provided on the glass substrates 12a, 12b by pasting them onto the outer surfaces of the glass substrates 12a, 12b.

Then, the operation of the transflective liquid crystal display device in the above described structure will be explained. Note that the operation in the reflective mode in which ambient light is used as a light source is the same as that of a normal transflective liquid crystal display device, and therefore explanations thereof will be omitted.

In the transmissive mode in which the light of the backlight 11 is used as a light source for the display, the light emitted from the backlight 11 in the reflective region B passes through the circularly polarized light plate 13. Since the circularly polarized light plate 13 is a right circularly polarized light plate, a part of the left circularly polarized light of the light which has passed through the circularly polarized light plate 13 is absorbed and becomes the right circularly polarized light.

When this right circularly polarized light enters the retardation film 12e of the liquid crystal panel 12, the phase of the right circularly polarized light is delayed by ¼. The light with the phase delay with ¼ becomes linearly polarized light and is reflected on the reflective film 12d. The phase of the light reflected on the reflective film 12d is delayed by the retardation film 12e by ¼ again. In this way, this linearly polarized light becomes right circularly polarized light again. Therefore, the right circularly polarized light passed through the retardation film 12e, reflected on the reflective film 12d and passed through the retardation film 12e again becomes the right circularly polarized light as is. That is, by being reflected on the reflective film 12d, the right circularly polarized light becomes the left circularly polarized light, but since it passes through the retardation film 12e twice, the phase thereof is delayed by 2′¼, and therefore it returns to the right circularly polarized light.

This right circularly polarized light passes through the circularly polarized light plate 13 which is the right circularly polarized light plate as is. Then, the right circularly polarized light is reflected on the reflective film 11b and diffused by the diffusing film 11a. When passing through the diffusing film 11a, with circular polarization canceled, the right circularly polarized light returns to the natural light as well as the light from the backlight 11. For this reason, the light reflected on this backlight 11 is added to the light directly emitted from the backlight 11 in the transmissive region A. That is, the light from the backlight 11 in the reflective region B which conventionally used to be wasted without being used can be used in a transmissive mode.

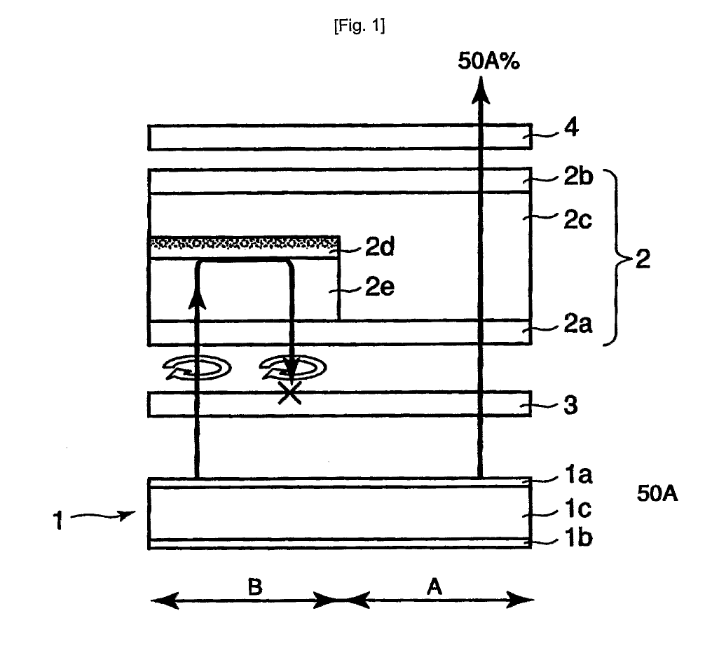

Then, the effect of the present invention will be explained using FIG. 1 and FIG. 2. Here, to facilitate an understanding, it is assumed that the amount of light emitted from the backlights 1, 11 is 100 and the area ratio (%) between the reflective region B and transmissive region A is B:A.

In the transflective liquid crystal display device shown in FIG. 1, the light emitted from the backlight 1 in the reflective region B in a transmissive mode cannot pass through the above described circularly polarized light plate 3, being wasted. Thus, only the light emitted from the backlight 11 in the transmissive region A is used for a display. Therefore, the utilization rate of the light used in the transmissive mode is 50 A %.

On the other hand, in the transflective liquid crystal display device according to the present invention shown in FIG. 2, the light emitted from the backlight 11 in the reflective region B in a transmissive mode can pass through the above described circularly polarized light plate 3, and can thereby be used for a display. Assuming that the reutilization rate of light is a, the utilization rate of this light is a B %. Furthermore, the utilization rate of the light emitted from the backlight 11 of the transmissive region A is 50 A % as described above. Therefore, the utilization rate of the light used in the transmissive mode is a B %+50 A %.

Note that the light utilization rate a is a value affected by the reflectance of the reflective film 11b and the degree of cancellation of circular polarization of the diffusing film 11a of the backlight 11, and a is small when the reflectance of the reflective film 11b and the degree of cancellation of circular polarization of the diffusing film 11a are small.

Thus, the transflective liquid crystal display device according to this embodiment can effectively use the light emitted from the backlight 11 in the reflective region B in a transmissive mode, and therefore when the brightness of the panel is kept at the same level, it is possible to suppress the necessary output of the backlight 11 more than the conventional one. As a result, it is possible to reduce power consumption of the backlight 11 and extend the life of the backlight 11. Furthermore, using the output of the backlight 11 at the same level as that of the conventional one can increase the brightness of the panel.

Furthermore, if the same transmittance as that of the conventional one in a transmissive mode is realized, it is possible to narrow the transmissive region (opening) A of each pixel, and thereby relatively widen the reflective region B. As a result, it is possible to increase the reflectance in the reflective mode and also improve the display performance in the reflective mode.

### Embodiment 2

This embodiment will describe another example of phase difference forming means provided in the reflective region of a liquid crystal panel. This embodiment will describe a case where an in-cell retarder is used for the phase difference forming means.

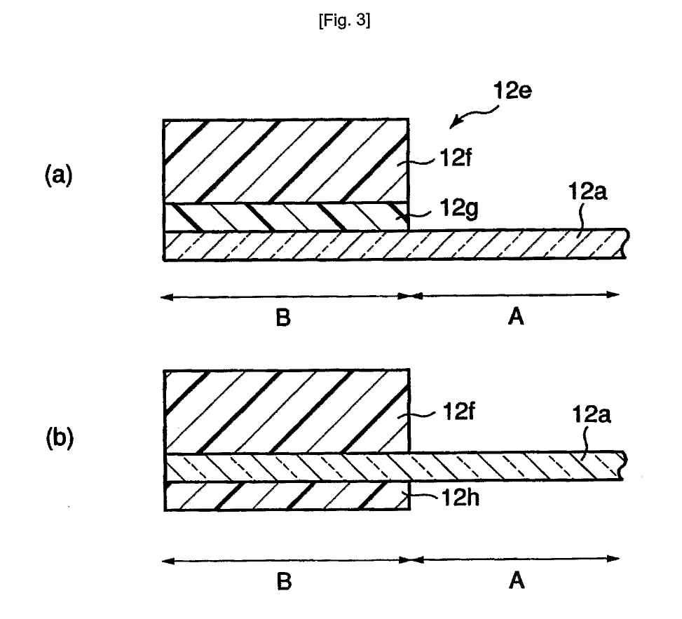

FIG. 3a is a sectional view showing another example of phase difference forming means in a transflective liquid crystal display device according to Embodiment 2 of the present invention. Here, in FIG. 3a, the same members as those shown in FIG. 2 are assigned the same reference numerals.

The retardation film 12e shown in FIG. 3a is constructed of an ordinary stepwise formation layer 12f and an in-cell retarder 12g. This in-cell retarder 12g can be constructed of a polymer liquid crystal layer with oriented liquid crystal molecules, etc.

When the retardation film 12e shown in FIG. 3a is formed, an orientation film (not shown) made of polyimide, etc., is formed on a glass substrate 12a first. Then, the orientation film is subjected to orientation processing by rubbing this orientation film. Then, the orientation film is coated with the polymer liquid crystal for orientation. In this way, the in-cell retarder 12g is formed on the glass substrate 12a. This makes it possible to form a phase difference. In the present invention, it is desirable to delay phase with ¼, and therefore it is preferable to control the film thickness and temperature accordingly.

Then, the stepwise member 12f is formed on the in-cell retarder 12g. A resin material can be used for the stepwise member 12f. When the stepwise member 12f is formed on the in-cell retarder 12g, the resin material is coated using a spin coating method, etc.

Further, a reflective film 12d is formed on the retardation film 12e (stepwise member 12f) as in the case of Embodiment 1. Then, the reflective film 12d and retardation film 12e (stepwise member 12f and in-cell retarder 12g) are patterned to form an opening corresponding to a transmissive region A.

Then, the operation of the transflective liquid crystal display device in the above described structure will be explained. The operation in a reflective mode using ambient light as a light source is the same as that of an ordinary transflective liquid crystal display device, and therefore explanations thereof will be omitted.

In a transmissive mode, when right circularly polarized light emitted from the backlight 11 in a reflective region B and passed through a circularly polarized light plate 13 enters the in-cell retarder 12g of the liquid crystal panel 2, the phase of the right circularly polarized light delays with ¼. The light with a phase delay with ¼ becomes linearly polarized light and is reflected on the reflective film 12d. The phase of the light reflected on the reflective film 12d is further delayed with ¼ in the in-cell retarder 12g again. This causes this linearly polarized light to return to the right circularly polarized light. Therefore, the right circularly polarized light passed through the in-cell retarder 12g, reflected on the reflective film 12d and passed through the in-cell retarder 12g becomes the right circularly polarized light as is. That is, the right circularly polarized light becomes left circularly polarized light by being reflected on the reflective film 12d, but since it passes through the in-cell retarder 12g twice, the phase thereof is delayed with 2′¼ and the light becomes the right circularly polarized light. This right circularly polarized light is reused as the light source in the transmissive mode as in the case of Embodiment 1. For this reason, as in the case of Embodiment 1, the light from the backlight 11 in the reflective region B which conventionally used to be wasted without being used can be used in the transmissive mode.

### Embodiment 3

This embodiment will describe a further example of phase difference forming means provided in the reflective region of a liquid crystal panel. This embodiment will describe a case where a retarder outside the substrate is used as the phase difference forming means.

FIG. 3b is a sectional view showing the other example of phase difference forming means in a transflective liquid crystal display device according to Embodiment 3 of the present invention. Here, in FIG. 3b, the same members as those shown in FIG. 2 are assigned to the same reference numerals.

The phase difference forming means shown in FIG. 3b is constructed of an ordinary stepwise formation layer 12f provided inside the liquid crystal cell, a retarder 12h provided outside the liquid crystal cell. This retarder 12h has a function of delaying phase with, for example, ¼ (approximately 100 to 200 nm). This retarder 12h can be constructed of a phase difference film and retardation film, etc.

When the phase difference forming means shown in FIG. 3b is formed, a stepwise member 12f is formed on a main surface of the glass substrate 12a on the liquid crystal cell side (inside the cell) first. When the stepwise member 12f is formed on the glass substrate 12a, a resin material, etc., is coated using a spin coating method, etc.

Furthermore, a reflective film 12d is formed on the stepwise member 12f as in the case of Embodiment 1. Then, the reflective film 12d and stepwise member 12f are patterned to form an opening corresponding to the transmissive region A.

Then, the retarder 12h is partially formed in the region on the main surface opposite to the liquid crystal cell (outside the cell) of the glass substrate 12a, in which the stepwise member 12f is formed. When a phase difference film is used as the retarder 12h, the phase difference film is partially pasted to the region corresponding to the region of the glass substrate 12a in which the stepwise member 12f is formed. On the other hand, when the retardation film is used as the retarder 12h, a resin material is coated using a spin coating method, etc., as in the case of Embodiment 1 and then patterning is performed in such a way that a retardation film remains in the region corresponding to the formation region of the stepwise member 12f.

Then, the operation of the transflective liquid crystal display device in the above described structure will be explained. The operation in a reflective mode using ambient light as a light source is the same as that of an ordinary transflective liquid crystal display device, and therefore explanations thereof will be omitted.

In a transmissive mode, when right circularly polarized light emitted from the backlight 11 in a reflective region B and passed through a circularly polarized light plate 13 enters the retarder 12h of the liquid crystal panel 2, the phase thereof is delayed with ¼. The light with a phase delay with ¼ becomes linearly polarized light and is reflected on the reflective film 12d. The phase of the light reflected on the reflective film 12d is further delayed with ¼ in the retarder 12h again. This causes this linearly polarized light to become the right circularly polarized light. Therefore, the right circularly polarized light passed through the retarder 12h, reflected on the reflective film 12d and passed through the retarder 12h again becomes the right circularly polarized light as is. That is, the right circularly polarized light becomes the left circularly polarized light by being reflected on the reflective film 12d, but since it passes through the retarder 12h twice, the phase thereof is delayed with 2′¼, thus becoming the right circularly polarized light. This right circularly polarized light is reused as the light source in the transmissive mode as in the case of Embodiment 1.

For this reason, as in the case of Embodiment 1, the light from the backlight 11 in the reflective region B which conventionally used to be wasted without being used can be used in the transmissive mode.

In this embodiment, the phase difference forming means is constructed of the stepwise member 12f and retarder 12h separately, which makes it possible to reduce the thickness of the retarder 12h.

The present invention is not limited to Embodiments 1 to 3 above, but can be implemented modified in various ways. For example, the present invention is not limited to materials described in Embodiments 1 to 3 above, but can be implemented modified in various ways.

Said embodiments 1 to 3 have described the case where the retardation film for delaying phase with ¼ is used, but the retardation film of the present invention is not limited to the retardation film for delaying phase with ¼ if the orientation of circularly polarized light can be at least reversed by allowing the light to pass through the film or layer twice. Furthermore, Embodiments 1 to 3 above have described the case where the circularly polarized light plates 13, 14 are pasted to the glass substrates 12a, 12b, but the present invention is applicable if the circularly polarized light plates 13, 14 are at least arranged outside the glass substrates 12a, 12b in the liquid crystal panel 12.

As described above, the transflective liquid crystal display device of the present invention comprises a pair of circularly polarized light members arranged outside the liquid crystal panel and a backlight arranged outside one circularly polarized light member of the pair of circularly polarized light members, wherein the reflective region has a reflective member for reflecting ambient light from an opposite side of backlight-arranging side in the liquid crystal panel, and the reflective region has phase difference forming means arranged on the backlight side of the reflective member, and therefore it is possible to reverse the polarization direction of circularly polarized light from the backlight in the reflective region and allow the light reflected on the reflective member to pass through the circularly polarized light member. As a result, the light from the backlight in the reflective region which conventionally used to be wasted without being used can be used in a transmissive mode.

### INDUSTRIAL APPLICABILITY

The present invention is applicable to a transflective liquid crystal display device used for a cellular phone or PDA (Personal Digital Assistant), etc.

1. A transflective liquid crystal display device having a liquid crystal panel in which liquid crystal material is sealed between a pair of substrates faced with each other and in which pixels formed on one substrate of said pair of substrates have transmissive regions and reflective regions, comprising:
a pair of circularly polarized light members arranged outside said liquid crystal panel; and
a backlight arranged outside one circularly polarized light member of said pair of circularly polarized light members,
wherein said reflective region has a reflective member for reflecting ambient light from an opposite side of backlight-arranging side in said liquid crystal panel, and said reflective region has phase difference forming means arranged on the backlight-arranging side of said reflective member.

2. The device as claimed in claim 1, wherein said phase difference forming means has a function of reversing a direction of circularly polarized light by allowing circularly polarized light to pass therethrough twice.

3. The device as claimed in claim 1, wherein said phase difference forming means is formed on said reflective regions in a main surface inside said liquid crystal panel on one substrate on the backlight-arranging side of the pair of substrates and said reflective member is formed on said phase difference forming means.

4. The device as claimed in claim 3, wherein said phase difference forming means is a retardation film for delaying phase with λ/4.

5. The device as claimed in claim 1, wherein said phase difference forming means also serves as a stepwise member for adjusting a balance between transmittance in said transmissive region and reflectance in said reflective region.

6. The device as claimed in claim 1, wherein said phase difference forming means is orientation-processed polymer liquid crystal layer.

7. The device as claimed in claim 6, wherein said polymer liquid crystal layer delays phase with λ/4.

8. The device as claimed in claim 1, wherein said phase difference forming means is formed on said reflective regions in a main surface outside said liquid crystal panel on one substrate on the backlight-arranging side of said pair of substrates.

9. The device as claimed in claim 8, wherein said phase difference forming means is a retardation film or a phase difference film for delaying phase with λ/4.
